(19) United States
(12) Patent Application Publication
(10) Pub. No.: US 2007/0238350 A1
(43) Pub. Date: Oct. 11, 2007

(54) Electrical adapter

(76) Inventor: Elliot Azoulay, Brooklyn, NY (US)

Correspondence Address: AMSTER, ROTHSTEIN & EBENSTEIN LLP, 90 PARK AVENUE, NEW YORK, NY, 10016, US

(21) Appl. No.: 11/398,972

(22) Filed: Apr. 5, 2006

(51) Int. Cl. H01R 13/72

(52) U.S. Cl. 439/501

(57) ABSTRACT

An electrical adapter including a housing, a USB port disposed on the housing, an electrical connector partially extending from the housing, and an input power receiver extending from the housing.

### TECHNICAL FIELD

The present invention is generally related to electrical adapters for use with small electrical and electronic devices.

### BACKGROUND

When traveling, people typically carry a phone charger to charge their cellular phones along with other adapters for powering and/or charging personal electronic devices, such as a digital camera, personal digital assistant (PDA) or I-pod® or other digital music players. Further, some electronic devices are configured to electrically connect to only a specific type of adapter, such as, for example, an adapter providing a USB (universal serial bus)port, so that a single standard adapter can not be used for multiple electronic devices. Thus, the traveler is faced with the daunting task of having to transport multiple adapters that add much weight and bulk to luggage. In addition, when arriving at a destination, the traveler needs to be situated in a locale that has more than one power source, such as a hotel room with multiple power outlets, that can provide power to each of the devices that require charging or powering. The need for multiple power receptacles can be a problem particularly when in an automobile or other vehicle.

Accordingly, there is a need for an electrical adapter that is versatile enough to provide power to more than one electronic device so as to avoid the need to transport multiple adapters and use multiple power outlets.

### SUMMARY OF THE INVENTION

An electrical adapter according to an exemplary embodiment of the invention includes a housing, a USB port disposed on the housing, an electrical connector partially extending from the housing, and an input power receiver extending from the housing.

In at least one embodiment, the electrical connector includes a conductive wire coupled to a connector portion, wherein the connector portion is adapted to electrically connect with an electronic device for charging or powering the electronic device.

In at least one embodiment, the conductive wire is flexible along its length.

In at least one embodiment, a rotary member is disposed within the housing, and a portion of the conductive wire is wrapped around the rotary member to adjust an amount that the electrical connector extends from the housing in a retractable arrangement.

In at least one embodiment, the power receiver includes electrical plug blades for insertion into a power outlet.

In at least one embodiment, the power receiver includes a vehicle cigarette lighter connector for electrically connecting the adapter to a vehicle cigarette lighter.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a general schematic diagram of an electrical adapter according to an exemplary embodiment of the present invention;

FIG. 2 is a top plan view of an adapter according to an exemplary embodiment of the present invention;

FIG. 3 is a bottom plan view of the adapter of FIG. 2;

FIG. 4 is a side view of the adapter of FIG. 2;

FIG. 5 is a perspective view of the adapter of FIG. 2;

FIG. 6 shows the adapter of FIG. 2 with the connector partially extended from the housing;

FIG. 7 is a top plan view of an adapter according to an exemplary embodiment of the present invention;

FIG. 8 is a side view of the adapter of FIG. 7;

FIG. 9 is a bottom plan view of the adapter of FIG. 7; and

FIG. 10 is a perspective view of the adapter of FIG. 7.

### DETAILED DESCRIPTION OF PREFERRED EMBODIMENTS

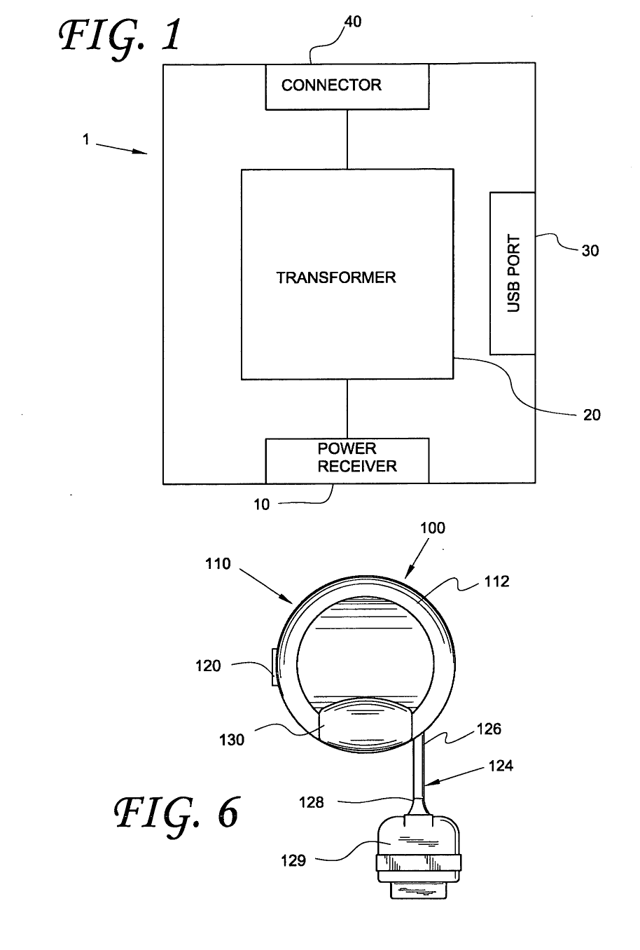

FIG. 1 is a general schematic diagram of an electrical adapter, generally designated by reference number 1, according to an exemplary embodiment of the present invention. The adapter 1 includes a power receiver 10, a transformer 20, a USB port 30 and a connector 40. The power receiver 10 receives power from a source, and may be, for example, a pair of plug blades for insertion into socket holes of a wall electrical outlet or a connector to an automobile cigarette lighter. The transformer 20 is composed of rectifying electrical circuitry that converts AC current into DC current for delivery to the USB port 30 and the connector 40. Since the feature of the present invention does not reside in the electrical circuitry of the transformer 20, a detailed description thereof is omitted herein. The transformer 20 preferably delivers 5V and 500 milliamperes of DC power to the USB port 30 for supplying power to standard USB-powered electrical devices, such as, for example, a digital camera or an I-Pod® or other digital music players. The transformer 20 also delivers electrical power to the electrical connector 40, which is preferably adapted for electrical connection to an electronic device, such as a cellular phone, for charging of the electronic device. It should be appreciated that, in other exemplary embodiments of the present invention, the adapter 1 may include more than one USB port for connection to more than one USB-enabled electronic device.

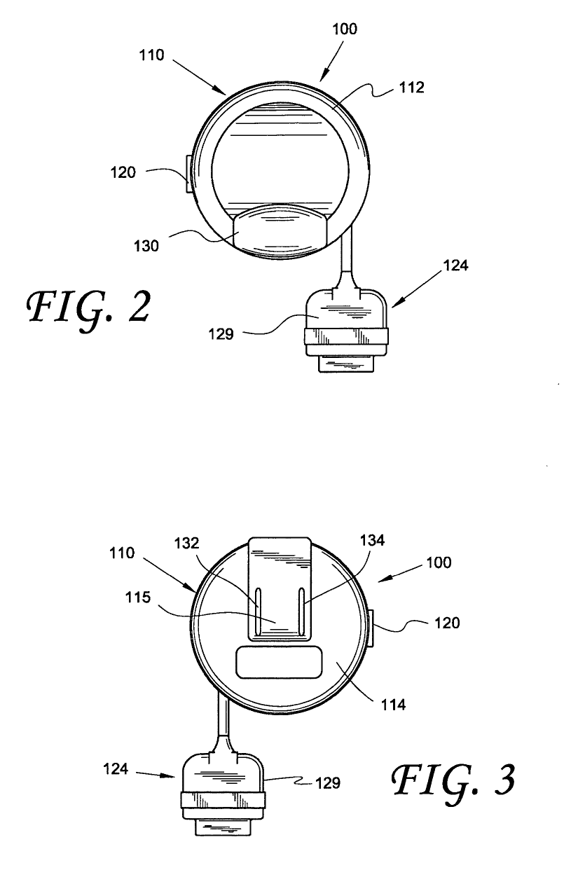

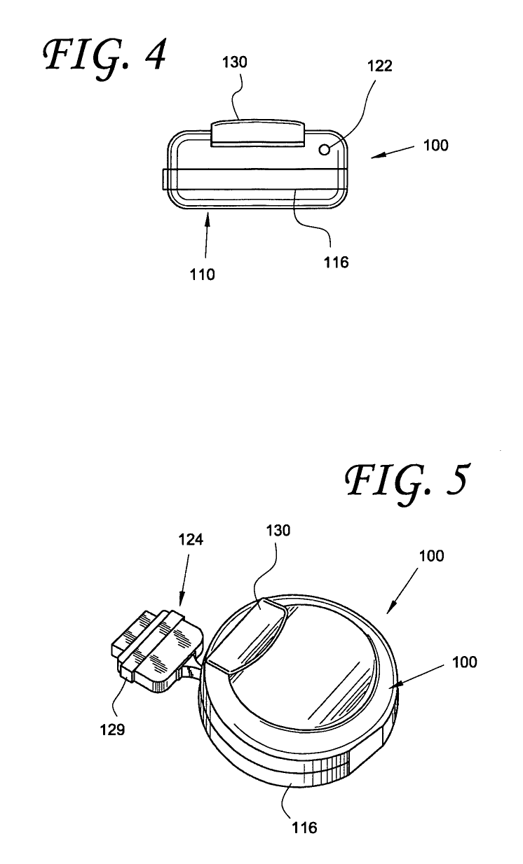

FIGS. 2-6 show an electrical adapter, generally designated by reference number 100, according to an exemplary embodiment of the present invention. FIG. 2 shows a top plan view of the adapter 100; FIG. 3 shows a bottom plan view of the adapter 100; FIG. 4 shows a side view of the adapter 100; and FIG. 5 shows a perspective view of the adapter 100. The adapter 100 includes a generally shortened-cylinder shaped housing, generally designated by reference number 110. It should be appreciated that the housing 110 may have any other shape, such as, for example, rectangular or spherical. The housing 110 includes a top wall 112, a bottom wall 114 and a side wall 116. A USB port 120 is disposed at one portion of the side wall 116. An opening 122 is disposed at another portion of the side wall 116, through which a connector, generally designated by reference number 124, extends. FIG. 6 shows the connector 124 partially extended from the housing 110 through the opening 122. The connector 124 preferably includes a conductive wire 126 having a connector coupling end 128 electrically connected to a connector portion 129. The connector 124 may be extendable from the housing 110 by any suitable means, such as by using a flexible conductive wire 126 or by winding the conductive wire 126 about a rotary member (not shown) within the housing 110. Winding a conductive wire of a connector about a rotary member within an adapter housing is well known in the art, for example as disclosed in U.S. Pat. No. 6,655,984, incorporated herein by reference. A button 130 may be disposed on the housing 110, the manipulation of which locks and unlocks the conductive wire 126 at un-spooled lengths from the rotary member.

The adapter 100 also includes a pair of plug blades 132, 134 that are foldable into a storage position within a recess 115 formed in the bottom wall 114 of the housing 110. As is well known in the art, the plug blades 132, 134 can be unfolded from the bottom wall 114 and inserted into a power outlet for delivery of AC voltage to the adapter. Foldable plug blades are also known in the art, for example as disclosed in U.S. Pat. No. 6,655,984.

The ability to store the conductive wire 126 within the housing 110 and fold the plug blades 132, 134 into the storage position allows the adapter to be disposed in a compact storage configuration. The USB port 120 and connector 124 also allow the adapter 100 to function as both an electrical charger for electronic devices, such as cellular phones, as well as a power source for USB-powered devices.

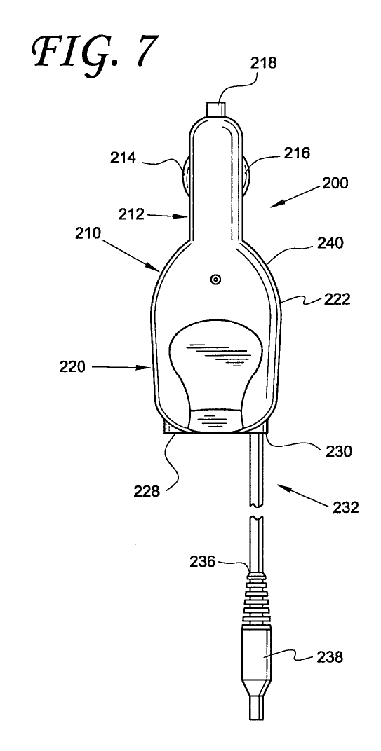

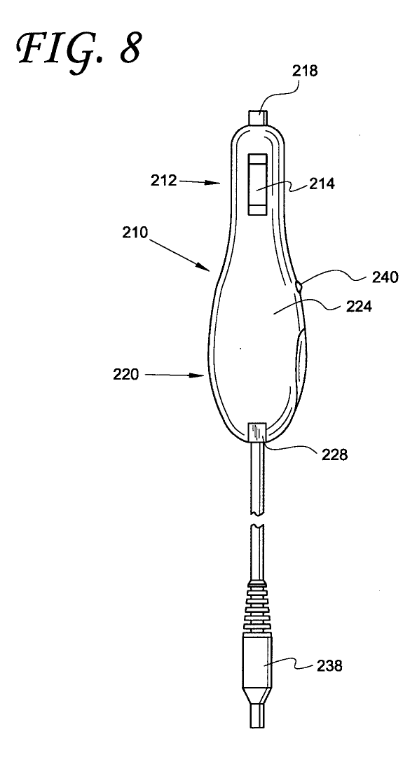

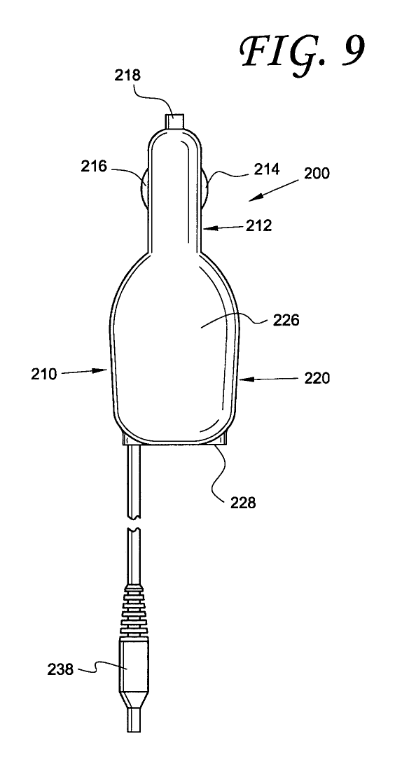

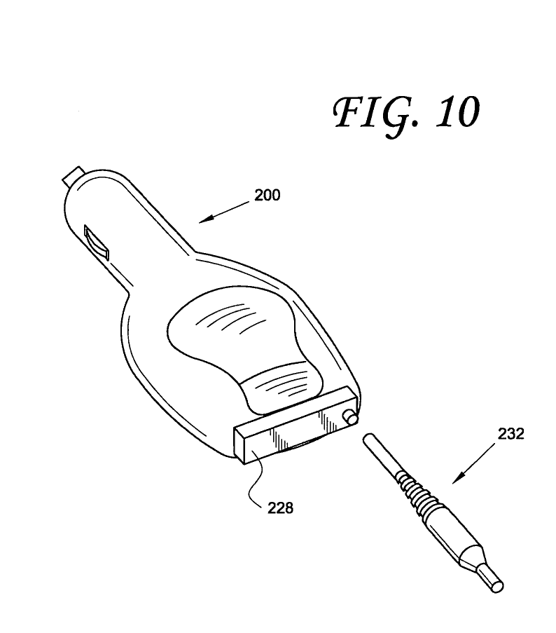

FIGS. 7-10 show an adapter, generally designated by reference number 200, according to another exemplary embodiment of the present invention. FIG. 7 shows a top plan view of the adapter 200; FIG. 8 shows a side view of the adapter 200; FIG. 9 shows a bottom plan view of the adapter 200; and FIG. 10 shows a perspective view of the adapter 200. The adapter 200 is similar to the adapter 100 of the previous embodiment accept that it is configured for electrical connection to a vehicle cigarette lighter. In particular, the adapter 200 includes a housing, generally designated by reference number 210. The housing 210 includes a barrel-shaped cigarette-lighter connector portion, generally designated by reference number 212, and an adapter portion, generally designated by reference number 220, extending from the cigarette-lighter connector portion 212. The adapter portion 220 includes a top wall 222, a side wall 224 and bottom wall 226. A USB port 228 is disposed at one portion of the side wall 224. An opening 230, through which a connector, generally designated by reference number 232, extends, is disposed at another portion of the side wall 224. The connector 232 includes a conductive wire 234 having a connector coupling end 236 electrically connected to a connector portion 238. As in the previous embodiment, the connector 232 may be extendable from the housing 210 by any suitable means, such as by using a flexible conductive wire 234 or by winding the conductive wire 234 about a rotary member (not shown) within the housing 210.

The cigarette-lighter connector portion 212 include side terminals 214, 216 and an end terminal 218. As is known in the art, the side terminals 214, 216 and end terminal 218 make electrical contact with a vehicle cigarette lighter socket upon insertion of the connector portion 212 into the socket, as disclosed in, for example, U.S. Pat. No. 6,551,142, incorporated herein by reference. The adapter 200 of FIGS. 7-10 incorporates conventional circuitry reducing the 12 VDC to the appropriate output at the USB port 228 and at the connector portion 238.

A light 240 may be disposed on the top wall 222 of the adapter portion 220 of the housing 210, which is activated when power is delivered to the adapter 200 to indicate that the adapter 200 has been properly connected to a vehicle cigarette lighter. A button 242 may also be disposed on the housing 210, the manipulation of which locks and unlocks the conductive wire 126 at un-spooled lengths from the rotary member.

In an embodiment of the present invention, although not shown, the connector 124, 238 can be disconnected from the conductive wire 126, 234 and replaced with a different connector to enable the adapter to be used with cell phones from different manufacturers. Any conventional means of changing the connector can be used. Similarly, although not shown, the USB port can be replaced by USB cable connected internally to the adapter which may or may not be retractable.

Now that the preferred embodiments have been shown and described in detail, various modifications and improvements thereon will be readily apparent to those skilled in the art. Accordingly, the spirit and scope of the present invention is to be construed broadly and be limited only by the appended claims, and not by the foregoing specification.

1. An electrical adapter comprising:
a housing;
a USB port disposed on the housing;
an electrical connector partially extending from the housing; and
an input power receiver extending from the housing, the power receiver comprising a vehicle cigarette lighter connector for electrically connecting the adapter to a vehicle cigarette lighter.

2. The electrical adapter of claim 1, wherein the electrical connector comprises a conductive wire coupled to a connector portion, wherein the connector portion is adapted to electrically connect with an electronic device for charging the electronic device.

3. The electrical adapter of claim 2, wherein the conductive wire is flexible along its length.

4. The electrical adapter of claim 2, wherein a rotary member is disposed within the housing, and a portion of the conductive wire is wrapped around the rotary member to adjust an amount that the electrical connector extends from the housing.

5. (canceled)

6. (canceled)

7. An electrical adapter comprising:
a housing having a top wall, a bottom wall and a side wall;
a USB port disposed at one portion of the side wall;
an opening formed at another portion of the side wall;
an electrical connector extending through the opening from inside the housing; and
an input power receiver extending from the housing, the power receiver comprising a vehicle cigarette lighter connector for electrically connecting the adapter to a vehicle cigarette lighter.

8. The electrical adapter of claim 7, wherein the electrical connector comprises a conductive wire coupled to a connector portion, wherein the connector portion is adapted to electrically connect with an electronic device for charging the electronic device.

9. The electrical adapter of claim 8, wherein the conductive wire is flexible along its length.

10. The electrical adapter of claim 8, wherein a rotary member is disposed within the housing, and a portion of the conductive wire is wrapped around the rotary member to adjust an amount that the electrical connector extends from the housing.

11. (canceled)

12. (canceled)
